(19) United States
(12) Patent Application Publication
(10) Pub. No.: US 2008/0206579 A1
(43) Pub. Date: Aug. 28, 2008

(54) COMPOSITIONS CONTAINING A SILANOL FUNCTIONAL POLYMER AND RELATED HYDROPHILIC COATING FILMS

(75) Inventors: Ellen C. LaLumere, Pittsburgh, PA (US); Kaliappa G. Ragunathan, Gibsonia, PA (US); Gary A. Altavilla, Pittsburgh, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/114,035

(22) Filed: May 2, 2008

Related U.S. Application Data
(63) Continuation-in-part of application No. 11/260,983, filed on Oct. 28, 2005.

(51) Int. Cl. B32B 9/04

(52) U.S. Cl. 428/447

(57) ABSTRACT

Disclosed are coating compositions that include a polymer comprising silanol functional groups. Also disclosed are substrates coated with such compositions, methods for coating substrates with such compositions, and methods for imparting self cleaning properties to a substrate.

### CROSS-REFERENCE TO RELATED APPLICATIONS

This application is a continuation-in-part of U.S. patent application Ser. No. 11/260,983 filed Oct. 28, 2005, entitled “Compositions Containing a Silanol Functional Polymer and Related Hydrophilic Coating Films,” which is incorporated herein by reference.

### FIELD OF THE INVENTION

The present invention is directed to coating compositions that include a polymer comprising silanol functional groups. The present invention is also directed to substrates coated with such compositions, methods for coating substrates with such compositions, and methods for imparting self cleaning properties to a substrate.

### BACKGROUND INFORMATION

Coating compositions that exhibit hydrophilic properties are often desirable for certain coating applications, such as where coated surfaces exhibiting anti-fouling, easy-to-clean, self-cleaning, and/or anti-fogging properties are desired. Such coatings can be particularly useful, by way of example, for application to surfaces exposed to the outdoor environment. Building structures, automobiles, and other articles that are exposed to the outdoors are likely to come in contact with various contaminants, such as dirt, oil, dust, and clay, among others. A surface with a hydrophilic coating deposited thereon may be self-cleaning because the coating has the ability to wash those contaminants away when the surface comes in contact with water, such as during a rainfall.

In view of these and other advantages, various hydrophilic coating compositions have been proposed. Many of these coatings achieve their hydrophilicity through the action of a photocatalytic material, such as titanium dioxide. The use of such materials can, however, in at least certain applications, be problematic. For example, when applying such a material over an organic film, such as a typical coating composition used in automotive applications, the photocatalytic material may contact the organic film. Because an —OH free radical is generated by the photocatalytic action of a photocatalytic material, the underlying organic film is susceptible to degradation.

As a result, it would be advantageous to provide a coating composition that can produce thin coating films that exhibit hydrophilic properties and, therefore, self-cleaning properties. Furthermore, it would be desirable to provide such compositions that do not necessarily rely on the use of a photocatalytic material to produce such properties.

### SUMMARY OF THE INVENTION

In certain respects, the present invention is directed to low-solids, aqueous coating compositions comprising a polymer comprising silanol functional groups which are present on the polymer in an amount sufficient to give the polymer a silanol value of at least 300.

The present invention is also directed to substrates at least partially coated with a coating film deposited from such a composition, as well as methods of coating a substrate with such a composition.

In another respect, the present invention is directed to a coating film comprising a polymer comprising silanol groups that are present on the polymer in an amount sufficient to render the coating film hydrophilic.

In yet another respect, the present invention is directed to methods for imparting self cleaning properties to at least a portion of a substrate. The methods comprise (i) applying to the substrate a low-solids, aqueous coating composition comprising a polymer comprising silanol groups, and (ii) allowing the composition to cure such that the resulting coating film is hydrophilic.

These and other aspects will become more apparent from the following description.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, certain embodiments of the present invention are directed to “low-solids” coating compositions. As used herein, the term “low-solids” refers to compositions that have a total organic resin solids content of less than 25 percent by weight, such as no more than 15 percent by weight, based on the total weight of the composition. In certain embodiments, the low-solids compositions of the present invention have a total organic resin solids content of 1 to 10 percent by weight, such as 1 to 3 percent by weight, based on the total weight of the composition.

Certain embodiments of the present invention are directed to “aqueous” coating compositions. As used herein, the term “aqueous coating composition” means that the solvent or carrier fluid for the composition contains water in an amount sufficient to hydrolyze silane groups existing on a polymer in the composition such that, upon hydrolysis, the polymer has a silanol value of at least 300. In certain embodiments, the solvent or carrier fluid in such aqueous compositions primarily or principally comprises water. For example, in certain embodiments, the carrier fluid is at least 50 weight percent water, or, in some cases, at least 80 percent water or, in yet other cases, the carrier fluid consists essentially of only water.

In certain embodiments, the coating compositions of the present invention are in the form of an aqueous dispersion comprising a polymer comprising silanol functional groups. As used herein, the term “aqueous dispersion” refers to a composition wherein an organic component is in a dispersed phase as particles distributed throughout a continuous phase, which includes water. As used herein, the term “organic component” is meant to encompass all of the organic species present in the aqueous dispersion, including any polymers, as well as any organic solvents.

As used herein, the term “polymer” is meant to include both homopolymers and copolymers. As indicated, certain embodiments of the present invention are directed to compositions that comprise a polymer comprising silanol functional groups which are present on the polymer in an amount sufficient to give the polymer a silanol value of at least 300, such as 300 to 1600, or, in some cases, 400 to 800, or, in yet other cases, 500 to 800. For purposes of the present invention, the term “silanol value” refers to the calculated amount of KOH (in milligrams) required to theoretically convert all of the silanol groups existing in one gram of a polymer to potassium salt, assuming that one KOH molecule converts one silanol group to potassium salt. The Examples herein illustrate the proper way to determine the “silanol value” of a polymer for purposes of the present invention.

In certain embodiments of the compositions of the present invention, the polymer comprises an acrylic polymer. As used herein, the term “acrylic” polymer refers to those polymers that are well known to those skilled in the art which result from the polymerization of one or more ethylenically unsaturated polymerizable materials. Acrylic polymers suitable for use in the present invention can be made by any of a variety of methods, as will be understood by those skilled in the art. In certain embodiments, such acrylic polymers are made by addition polymerization of different unsaturated polymerizable materials, at least one of which is a silane-containing ethylenically unsaturated polymerizable material. The result of such a polymerization is an acrylic polymer that comprises hydrolyzable silane functional groups. Examples of hydrolyzable silane groups include, without limitation, groups having the structure Si—Xₙ (wherein n is an integer having a value ranging from 1 to 3 and X is selected from chlorine, bromine, iodine, alkoxy esters, and/or acyloxy esters).

Examples of silane-containing ethylenically unsaturated polymerizable materials, suitable for use in preparing such acrylic polymers include, without limitation, ethylenically unsaturated alkoxy silanes and ethylenically unsaturated acyloxy silanes, more specific examples of which include acrylatoalkoxysilanes, such as gamma-acryloxypropyl trimethoxysilane and gamma-acryloxypropyl triethoxysilane, and methacrylatoalkoxysilanes, such as gamma-methacryloxypropyl trimethoxysilane, gamma-methacryloxypropyl triethoxysilane and gamma-methacryloxypropyl tris-(2-methoxyethoxy) silane; acyloxysilanes, including, for example, acrylato acetoxysilanes, methacrylato acetoxysilanes and ethylenically unsaturated acetoxysilanes, such as acrylatopropyl triacetoxysilane and methacrylatopropyl triacetoxysilane. In certain embodiments, it may be desirable to utilize monomers which, upon addition polymerization, will result in an acrylic polymer in which the Si atoms of the resulting hydrolyzable silyl groups are separated by at least two atoms from the backbone of the polymer.

In certain embodiments, the amount of the silane-containing ethylenically unsaturated polymerizable material used in the total monomer mixture is chosen so as to result in the production of an acrylic polymer comprising silane groups that, upon hydrolysis in an aqueous medium, convert to silanol functional groups which are present on the acrylic polymer in an amount sufficient to give the polymer a silanol value of at least 300, such as 300 to 1600, or, in some cases 400 to 800, or, in yet other cases, 500 to 800, as indicated earlier. In certain embodiments, to achieve the desired silanol content in the final polymer, the amount of such silane-containing ethylenically unsaturated polymerizable materials comprises at least 50 percent by weight, such as at least 70 percent by weight, with weight percents being based on the weight of the total monomer combination used to prepare the acrylic polymer.

In certain embodiments, the acrylic polymer suitable for use in the present invention is the reaction product of one or more of the aforementioned silane-containing ethylenically unsaturated polymerizable materials and an ethylenically unsaturated polymerizable material that comprises carboxylic acid groups or an anhydride thereof to impart acid functionality to the acrylic polymer. Examples of suitable ethylenically unsaturated acids and/or anhydrides thereof include, without limitation, acrylic acid, vinyl phosphoric acid, methacrylic acid, itaconic acid, crotonic acid, maleic acid, maleic anhydride, citraconic anhydride, itaconic anhydride, ethylenically unsaturated sulfonic acids and/or anhydrides such as sulfoethyl methacrylate, and half esters of maleic and fumaric acids, such as butyl hydrogen maleate and ethyl hydrogen fumarate in which one carboxyl group is esterified with an alcohol. Ethylenically unsaturated carboxylic acids and/or anhydrides are used in certain embodiments. In certain embodiments, such acid and/or anhydride functional ethylenically unsaturated polymerizable materials are utilized in an amount sufficient to result in an acrylic polymer having acid value of up to 400, such as 20 to 80. For purposes of the present invention, the term “acid value” refers to the number of milligrams of KOH required to neutralize the acid in one gram of a test material and can be measured according to the method described in ASTM D1639. In certain embodiments, the amount of such acid and/or anhydride functional ethylenically unsaturated polymerizable materials ranges from up to 50 percent by weight, such as up to 10 percent by weight, based on the weight of the total monomer combination used to prepare the acrylic polymer.

In certain embodiments, the acrylic polymer suitable for use in the present invention is the reaction product of one or more of the aforementioned silane-containing ethylenically unsaturated polymerizable materials and an amino-functional ethylenically unsaturated polymerizable material to impart amine functionality to the acrylic polymer rather than acid functionality. Examples of suitable amino-functional ethylenically unsaturated polymerizable materials include, without limitation, p-dimethylaminomethyl styrene, t-butylaminoethylmethacrylate, p-dimethylaminoethyl styrene; dimethylaminomethyl acrylamide, dimethylaminopropyl acrylamide, dimethylaminopropyl methacrylamide, dimethylaminomethyl methacrylamide; dimethylaminoethyl (meth)acrylate, diethylaminoethyl (meth)acrylate, dimethylaminopropyl (meth)acrylate, and dimethylaminopropyl (meth)acrylamide. In certain embodiments, such amino-functional ethylenically unsaturated polymerizable materials are utilized in an amount sufficient to result in an acrylic polymer having amine value of up to 400, such as 10 to 80. In certain embodiments, the amount of such materials comprises up to 50 percent by weight, such as up to 10 percent by weight, based on the weight of the total monomer combination used to prepare the acrylic polymer. For purposes of the present invention, the term “amine value” refers to the number of milliequivalents of titratable amine in one gram of a test material multiplied by 56.1. See Siggia, Sidney “Quantitative Organic Analysis via Functional Groups”, John Wiley & Sons, New York, N.Y. 1979.

In certain embodiments, in addition to or in lieu of the acid or amino-functional materials listed above, the acrylic polymer suitable for use in the present invention may be the reaction product of a non-ionic polymerizable material that is capable of rendering the resultant acrylic polymer water dispersible. Suitable materials for this purpose include, for example, (meth)acryloalkoxypolyalkylenes, such as, (meth)acryloalkoxyethylene glycols and/or ethers thereof, such as, for example, methoxypolyethylene glycol and/or butoxypolyethylene glycol. Such materials are commercially available and include, for example, MPEG 350 MA from Sartomer and the TONE™ series of materials from Dow Chemical. In certain embodiments, the amount of such materials comprises up to 50 percent by weight, such as up to 10 percent by weight, based on the weight of the total monomer combination used to prepare the acrylic polymer.

In certain embodiments, the acrylic polymer present in certain embodiments of the coating compositions of the present invention is also made from ethylenically unsaturated polymerizable material(s) substantially, or, in some cases, completely free of acid, amine, silane, and/or hydroxyl groups. Examples of such materials, which are suitable for use in preparing the acrylic polymer utilized in certain embodiments of the coating compositions of the present invention, are vinyl monomers, such as alkyl, cycloalkyl, or aryl acrylates and methacrylates having 1 to 6 carbon atoms in the esterifying group. Specific examples include methyl methacrylate and n-butyl methacrylate. Other suitable materials include lauryl methacrylate, 2-ethylhexyl methacrylate, isobornyl methacrylate, and cyclohexyl methacrylate. An aromatic vinyl monomer that is often included is styrene. Other materials that may be used are ethylenically unsaturated materials such as monoolefinic and diolefinic hydrocarbons, unsaturated esters of organic and inorganic acids, amides and esters of unsaturated acids, nitriles, and unsaturated acids. Examples of such monomers include, without limitation, 1,3-butadiene, acrylamide, acrylonitrile, alpha-methyl styrene, alpha-methyl chlorostyrene, vinyl butyrate, vinyl acetate, allyl chloride, divinyl benzene, diallyl itaconate, triallyl cyanurate, as well as mixtures thereof. In certain embodiments, the amount of ethylenically unsaturated polymerizable material(s) free of acid, amino, silane, and/or hydroxyl groups comprises up to 50 percent by weight, such as up to 30 percent by weight, based on the weight of the total monomer combination used to prepare the acrylic polymer.

In certain embodiments, the acrylic polymer utilized in certain embodiments of the coating compositions of the present invention is synthesized from a combination of unsaturated polymerizable materials comprising (a) 50 to 98 percent by weight, such as 70 to 90 percent by weight, of silane-containing ethylenically unsaturated polymerizable material(s); (b) 1 to 10 percent by weight, such as 3 to 6 percent by weight, of ethylenically unsaturated polymerizable materials that comprise carboxylic acid groups or an anhydride thereof; and (c) 1 to 49 percent by weight, such as 10 to 30 percent by weight, of ethylenically unsaturated polymerizable material(s) that are free of amine, acid, silane, and/or hydroxyl groups.

In certain embodiments, the acrylic polymer is formed by solution polymerization of the ethylenically unsaturated polymerizable material(s) in the presence of a polymerization initiator, such as azo compounds, such as alpha alpha′-azobis(isobutyronitrile), 2,2′-azobis (methylbutyronitrile) and 2,2′-azobis(2,4-dimethylvaleronitrile); peroxides, such as benzoyl peroxide, cumene hydroperoxide and t-amylperoxy-2-ethylhexanoate; tertiary butyl peracetate; tertiary butyl perbenzoate; isopropyl percarbonate; butyl isopropyl peroxy carbonate; and similar compounds. The quantity of initiator employed can be varied considerably; however, in most instances, it is desirable to utilize from 0.1 to 10 percent by weight of initiator based on the total weight of copolymerizable monomers employed. A chain modifying agent or chain transfer agent may be added to the polymerization mixture. The mercaptans, such as dodecyl mercaptan, tertiary dodecyl mercaptan, octyl mercaptan, hexyl mercaptan and the mercaptoalkyl trialkoxysilanes, such as 3-mercaptopropyl trimethoxysilane, may be used for this purpose as well as other chain transfer agents, such as cyclopentadiene, allyl acetate, allyl carbamate, and mercaptoethanol.

In certain embodiments, the polymerization reaction for the mixture of monomers to prepare the acrylic polymer is carried out in an organic solvent medium utilizing conventional solution polymerization procedures which are well known in the addition polymer art as illustrated with particularity in, for example, U.S. Pat. Nos. 2,978,437; 3,079,434 and 3,307,963, the relevant disclosures of which being incorporated by reference herein. Organic solvents which may be utilized in the polymerization of the monomers include virtually any of the organic solvents often employed in preparing acrylic or vinyl polymers such as, for example, alcohols, ketones, aromatic hydrocarbons or mixtures thereof. Illustrative of organic solvents of the above type which may be employed are alcohols such as lower alkanols containing 2 to 4 carbon atoms, including ethanol, propanol, isopropanol, and butanol; ether alcohols, such as ethylene glycol monoethyl ether, ethylene glycol monobutyl ether, propylene glycol monomethyl ether, and dipropylene glycol monoethyl ether; ketones, such as methyl ethyl ketone, methyl N-butyl ketone, and methyl isobutyl ketone; esters, such as butyl acetate; and aromatic hydrocarbons, such as xylene, toluene, and naphtha.

In certain embodiments, the polymerization of the ethylenically unsaturated components is conducted at from 0° C. to 150° C., such as from 50° C. to 150° C., or, in some cases, from 80° C. to 120° C.

Certain embodiments of the coating compositions of the present invention are made by forming an aqueous dispersion comprising the previously described acrylic polymer. Suitable, but non-limiting, methods for making such an aqueous dispersion are set forth in the Examples herein. In certain embodiments, the aqueous dispersion comprising the acrylic polymer is prepared by first preparing an acid-functional acrylic polymer in an organic solvent (as described above) and then neutralizing acid groups on the acrylic polymer with an alkaline material, such as an amine, during or prior to contacting the polymer with water. Suitable amines that may be used for this purpose include, but are not limited to, dialkanolamines, trialkanolamines, alkylalkanolamines, and arylalkanolamines containing from 2 to 18 carbon atoms in the alkanol, alkyl, and aryl chains. Specific examples include N-ethylethanolamine, N-methylethanolamine, dimethylethanolamine, diethanolamine, triethanolamine, N-phenylethanolamine and diisopropanolamine. Also suitable are amines which do not contain hydroxyl groups, such as trialkylamines, diamines and mixed alkyl-aryl amines and substituted amines in which the substituents are other than hydroxyl can also be used. Specific examples of these amines are triethylamine, methylethylamine, 2-methylpropylamine, diethylamine, dipropylamine, dibutylamine, dicocoamine, diphenylamine, N-methylaniline, diisopropylamine, methylphenylamine and dicyclohexylamine. Also, amines with ring structures such as morpholine, piperidine, N-methylpiperazine and N-hydroxyethylpiperazine can be used. Ammonia can also be used and is considered for the purposes of this application to be an amine.

As will be appreciated, in the case where the polymer is cationic, i.e., it contains amino-functionality, as described above, embodiments of the coating compositions of the present invention can be made by forming an aqueous dispersion comprising such a polymer according to the method described in the Examples herein. In certain embodiments, such an aqueous dispersion is prepared by first preparing an amino-functional polymer in an organic solvent and then neutralizing the amino groups with an acidic material, during or prior to contacting the polymer with water.

In certain embodiments, the continuous phase of the aqueous dispersion comprises exclusively water. In some embodiments, however, organic solvent may be present in the aqueous dispersion as well (as part of the dispersed phase) to, for example, assist in lowering the viscosity of the polymer(s) to be dispersed. For example, in certain embodiments, the aqueous dispersion comprises up to 50 weight percent, such as up to 25 weight percent, or, in some cases, up to 15 weight percent organic solvent, with weight percent being based on the total weight of the aqueous dispersion. Examples of suitable solvents which can be incorporated in the organic component of the aqueous dispersion are alcohols, such as ethanol and/or isopropanol, xylene, ketones, such as methyl amyl ketone, methyl isoamyl ketone, and/or methyl isobutyl ketone, and/or an acetate, such as n-butyl acetate, t-butyl acetate, and/or butyl carbitol acetate. In certain embodiments, the continuous phase is present in an amount sufficient to result in a low-solids coating composition.

In some cases, the polymer comprising silanol functional groups described above may be the only polymeric material present in the composition, however, in other cases, such a polymer may be present in the composition in combination with other polymeric materials. In certain embodiments of the present invention, therefore, the polymer comprising silanol functional groups is present in an amount of at least 25 percent by weight, such as at least 50 percent by weight, with the weight percents being based on the total weight of organic resin solids in the composition.

In certain embodiments, the coating compositions of the present invention also comprise a photocatalytic material. As used herein, the term “photocatalytic material” refers to a material that is photoexcitable upon exposure to, and absorption of, radiation, such as ultraviolet or visible radiation. In certain embodiments of the present invention, the photocatalytic material comprises a metal oxide, such as zinc oxide, tin oxide, ferric oxide, dibismouth trioxide, tungsten trioxide, strontium titanate, titanium dioxide (anatase, brookite, and/or rutile forms), or mixtures thereof. In certain embodiments of the present invention, at least a portion of the photocatalytic material is present in the composition in the form of particles having an average crystalline diameter of 1 to 100 nanometers, such as 3 to 35 nanometers, or, in yet other embodiments, 7 to 20 nanometers.

In certain embodiments of the present invention, the photocatalytic material is provided in the form of a sol comprising particles of photocatalytic material dispersed in water, such as a titania sol. Such sols are readily available in the marketplace. Examples of such materials, which are suitable for use in the present invention, include, without limitation, S5-300A and S5-33B available from Millennium Chemicals, STS-01, STS-02, and STS-21 available from Ishihara Sangyo Corporation, and NTB-1, NTB-13 and NTB-200 available from Showa Denko Corporation.

In certain embodiments of the present invention, the amount of the photocatalytic material that is present in the composition ranges from 0.05 to 5 percent by weight, such as 0.1 to 0.75 percent by weight, with weight percents being based on the total weight of the composition.

In certain embodiments of the present invention, however, the coating composition is substantially free or, in some cases, completely free, of a photocatalytic material. As used herein, the term “substantially free” means that the material being discussed is present, if at all, as an incidental impurity. In other words, the material does not affect the properties of the composition. As used herein, the term “completely free” means that the material is not present at all.

In certain embodiments, the coating compositions of the present invention also comprise a non-polymeric silanol containing material. As used herein, the term “non-polymeric silanol containing material” refers to materials that include silanol functional groups, but which lack an organic polymeric backbone. In certain embodiments, for example, such a non-polymeric silanol containing material comprises an essentially completely hydrolyzed organosilicate. As used herein, the term “organosilicate” refers to a compound containing organic groups bonded to a silicon atom through an oxygen atom. Suitable organosilicates include, without limitation, organoxysilanes containing four organic groups bonded to a silicon atom through an oxygen atom and organoxysiloxanes having a siloxane main chain ((Si—O)ₙ) constituted by silicon atoms. Such materials, as well as methods for their manufacture, are described in U.S. Pat. No. 6,599,976 at col. 3, line 57 to col. 10, line 58, the cited portion of which being incorporated herein by reference. Non-limiting examples of commercially available materials that are essentially completely hydrolyzed organosilicates, and which are suitable for use in the compositions of the present invention, are MSH-200, MSH-400, and MSH-500, silicates available from Mitsubishi Chemical Corporation, Tokyo, Japan and Shinsui Flow MS-1200, available from Dainippon Shikizai, Tokyo, Japan. In certain embodiments of the present invention, the composition comprises up to 80 percent by weight of the essentially completely hydrolyzed organosilicate, such as 20 to 80 percent by weight, with the weight percents being based on the total solids weight of the composition.

In certain embodiments, the non-polymeric silanol containing material comprises silica particles comprising silanol surface active groups. Examples of such materials include calcium ion-exchanged silica, colloidal silica, synthetic amorphous silica, and mixtures thereof. Suitable calcium ion-exchanged silica is commercially available from W. R. Grace & Co. as SHIELDEX® AC3. Suitable colloidal silica is available from Nissan Chemical Industries, Ltd. under the tradename SNOWTEX® and from Nayacol Nano Technologies Inc. under the tradename NexSil™. Suitable amorphous silica is available from W.R. Grace & Co. under the tradename SYLOID®). When used, such particles are often included in the compositions of the present invention in an amount of up to 80 percent by weight, such as 20 to 80 percent by weight, with the weight percents being based on the total solids weight of the composition.

In certain embodiments, the non-polymeric silanol containing material comprises a silicic acid, such as orthosilicic acid (H₄SiO₄), metasilicic acid (H₂SiO₃) and/or a condensation product thereof, such as, but not limited to, disilicic acid (H₂Si₂O₅) and/or pyrosilicic acid (H₆Si₂O₇). When used, the silicic acid is often included in the compositions of the present invention in an amount of up to 80 percent by weight, such as 20 to 80 percent by weight, with the weight percents being based on the total solids weight of the composition.

In certain embodiments, particularly when the composition is desired to be applied over a coated substrate, such as a substrate coated with an organic coating, the coating compositions of the present invention comprise a surfactant. Examples of surface active agents suitable for use in the present invention include, without limitation, the materials identified in U.S. Pat. No. 6,610,777 at col. 37, line 22 to col. 38, line 60 and U.S. Pat. No. 6,657,001 at col. 38, line 46 to col. 40, line 39, the cited portions of both of which being incorporated herein by reference.

In certain embodiments of the present invention, the amount of surfactant that is present in the composition ranges from 0.01 to 10 percent by weight, such as 0.01 to 5 percent by weight, or, in other embodiments, 0.1 to 3 percent by weight based on the total weight of the composition.

The coating compositions of the present invention may contain other components. Examples of such other components include various fillers, plasticizers, pigments, dyes, odorants, bittering agents, antioxidants, mildewcides, fungicides, flow control agents, such as thixotropes, and the like.

In certain embodiments, the compositions of the present invention may also include a crosslinking agent that comprises a material having functional groups, other than silanol groups, which are reactive with the silanol groups on the polymer. Suitable materials may include, for example, titanates, metal salts, certain organic alcohols, such as propylene glycol, ethylene glycol, trimethylolpropane, and pentaerythritol, and/or hydroxyl-functional polymers. Catalysts may also be included in the present compositions to, for example, accelerate the self-condensation of silanol groups with each other and/or reaction of the silanol groups with the aforementioned crosslinking agent. Suitable materials for this purpose include, without limitation, acids, bases, and tin complexes.

In certain embodiments, the coating compositions of the present invention are applied to at least a portion of a substrate and permitted to dry and/or cure. Suitable substrates that may be coated include any substrate as would be apparent to one skilled in the art in view of this disclosure, including various metals, plastics, previously coated substrates, wood, glass, and the like.

In certain embodiments, the coating compositions of the present invention are suitable for application to substrates formed from a variety of materials, including, for example, a variety of human and/or animal materials, such as keratin, fur, skin, teeth, nails, and the like; a variety of plant materials, including, trees, seeds, agricultural lands, such as grazing lands, crop lands and the like; turf-covered land areas, e.g., lawns, golf courses, athletic fields, etc., and other land areas, such as forests and the like; metallic materials; polymeric materials; cellulosic-containing materials; textile materials; compressible materials; silicatic materials; masonry materials; and/or mixtures of any of the aforementioned materials.

Application of the coating composition to the substrate can be accomplished by any suitable means, such as wiping, dipping, spraying, rolling, brushing, etc.

It should be understood that as used herein, a “substrate” at least partially coated with a coating composition of the present invention refers to a composition formed directly on at least a portion of the substrate surface, as well as a composition formed over any coating or pretreatment material or adhesion promoter material which was previously applied to at least a portion of the substrate.

For example, in certain embodiments, the “substrate” to which the coating composition of the present invention is applied may include a bare surface, that is, the surface of the substrate has not been previously coated, treated, and/or otherwise modified with any material.

In other embodiments, the “substrate” may include a pretreated surface, that is, one or more pre-treatment materials, such as those commonly known in the art, has been applied to the surface of the substrate, including, for example, chrome, zinc, phosphate, and the like.

In yet other embodiments, the “substrate” may include a coated surface, that is, one or more coating compositions may have been previously applied to the substrate's surface prior to application of composition of the present invention. Suitable coating compositions include any coating composition as would be apparent to one skilled in the art, including, for example, oil-based coatings; latex-based coatings; stains; coating compositions comprising one or more film-forming resins, such as, for example, acrylic resins, polyester resins, silicone-polyester resins, polyvinylidene fluoride resins, polyurethane resins, alkyd resins, epoxy resins, or mixtures thereof. In certain embodiments, the coating compositions may be water-based, while in other embodiments, they may be solvent-based. In certain embodiments, the coating compositions may be one component, while in other embodiments, the coating compositions may be more than one component, such as two-component, and may include one or more crosslinking agents. The coating compositions may be cured at ambient and/or elevated temperatures.

The aforementioned coating compositions may be present as one or more layers on the substrate, for example, primer, basecoat, topcoat, and/or clearcoat. In other embodiments, the coating compositions may be present not necessarily as layers, and instead on varying locations of the substrate, such as, for example, side-by-side. In still other embodiments, a combination of one or more different coating compositions may be present on the substrate of the present invention and may be present in the form of one or more layers and/or on varying locations of the substrate, as previously described.

In certain embodiments, the surface of the substrate may be mechanically abraded by any suitable means, such as by scuffing, sanding, buffing, sandblasting, etching, etc. In other embodiments, the surface of the substrate may be cleaned by any suitable means, such as by applying and/or wiping with any suitable cleaning material, including for example, an organic solvent.

In certain embodiments of the present invention, the substrate is a metallic substrate. Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. Cold rolled steel is also suitable when pretreated with, for example, a solution selected from the group consisting of a metal phosphate solution, an aqueous solution containing at least one Group 111B or IVB metal, an organophosphate solution, an organophosphonate solution, and combinations thereof. Also, suitable metallic substrates include silver, gold, and alloys thereof. Combinations of metals can also be used. Suitable metallic substrates may also include, composites of metals, wherein the substrate is reinforced with a fibrous material, such as metal fibers.

In another embodiment of the present invention, the substrate is a polymeric substrate. Suitable polymeric substrates can include any of the thermoplastic or thermoset synthetic materials well known in the art. Examples of suitable polymeric substrates are polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin, and mixtures of any of the foregoing. Other nonlimiting examples of suitable flexible polymeric substrates include thermoplastic polyolefin (“TPO”), reaction injected molded polyurethane (“RIM”) and thermoplastic polyurethane (“TPU”), thermoplastic polyesters, acrylic polymers, vinyl polymers such as polyvinyl chloride (“PVC”), polycarbonates, acrylonitrile-butadiene-styrene (“ABS”) copolymers, ethylene propylene diene terpolymer (“EPDM”) rubber, copolymers, and mixtures of any of the foregoing.

Suitable polymeric substrates may also include composite materials including fiber reinforced polymeric substrates constructed from a polymer, including any of those described above, that has been reinforced through the inclusion of, for example, fibrous materials, such as glass fiber or carbon fiber, or metal powders, or inorganic fillers, such as calcium carbonate, or other polymers, such as aromatic polyamide, to produce a polymeric substrate having increased rigidity, strength, and/or heat resistance relative to a similar polymeric substrate that does not include such reinforcing materials.

In certain embodiments, the substrate comprises a polyamide, such as a reinforced polyamide substrate. As used herein, the term “polyamide substrate” refers to a substrate constructed from a polymer that includes repeating units of the formula:

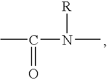

, wherein R is hydrogen or an alkyl group. The polyamide may be any of a large class of polyamides based on aliphatic, cycloaliphatic, or aromatic groups in the chain. They may be formally represented by the products of condensation of a dibasic amine with a diacid and/or diacid chloride, by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam), known as nylon 6, poly(lauryllactam), known as nylon 12, poly(omega-aminoundecanoic acid), known as nylon 11, poly(hexamethylene adipamide), known as nylon 6.6, poly(hexamethylene sebacamide), known as nylon 6.10, and/or an alkylene/arylene copolyamide, such as that made from meta-xylylene diamine and adipic acid (nylon MXD6). Amorphous polyamides, such as those derived from isophoronediamine or trimethylcyclohexanediamine, may also be utilized.

As used herein, the term “reinforced polyamide substrate” refers to a polyamide substrate constructed from a polyamide that has been reinforced through the inclusion of, for example, fibrous materials, such as glass fiber or carbon fiber, or inorganic fillers, such as calcium carbonate, to produce a polyamide having increased rigidity, strength, and/or heat resistance relative to a similar polyamide that does not include such reinforcing materials. Reinforced polyamides, which are suitable for use as a substrate material in accordance with certain embodiments of the present invention, are commercially available and include, for example, those materials commercially available from Solvay Advanced Polymers under the IXEF® name and, include, for example, the IXEF 1000, 1500, 1600, 2000, 2500, 3000 and 5000 series products; from EMS-Chemie Inc., Sumter, S.C., under the Grilamid®, Grivory®, Grilon® and Grilflex® tradenames; and DuPont Engineered Polymers, such as those sold under the Therm×® and Minlon® tradenames.

In certain embodiments, the substrate may be transparent. As used herein, “transparent”, when referring to a substrate means that a surface beyond the substrate is visible to the naked eye when viewed through the substrate. Depending upon the desired application, such a transparent article or substrate can have relatively low transmission, i.e., a spectral transmission of no more than 50% or, in some cases, no more than 10%, or, in yet other cases, no more than 5%, while, in other cases, the transparent article can have a relatively high transmission, i.e., a spectral transmission of more than 50%, in some cases at least 60%, or, in yet other cases, at least 80%. The foregoing spectral transmission values being measured at a wavelength ranging from 410 nanometers to 700 nanometers, based upon ASTM Standard No. D-1003 using a Hunter Lab COLORQUEST® II Sphere spectrophotometer that is available from Hunter Associates Laboratory, Inc. of Reston, Va.

The transparent substrates of certain embodiments of the present invention can be formed from a variety of materials. In certain embodiments of the present invention, the substrate comprises a rigid material, such as glass, including float glass. In certain embodiments of the present invention, the substrate comprises a flexible material, such as a polymeric material. Examples of polymeric materials include, but are not limited to, thermoplastic materials, such as polycarbonates, acrylonitrile butadiene styrene, blends of polyphenylene ether and polystyrene, polyetherimides, polyesters, polysulfones, acrylics, and copolymers and/or blends of any of these. Certain of these substrates can have a textured or roughened surface. Such surfaces can be prepared by any suitable method, such as any sandblasting or etching process known to those skilled in the art.

In certain embodiments, the transparent substrate comprises a polyamide. Examples of transparent polyamide substrates, which are commercially available, include Grilamid® TR grades, such as TR 55 and TR 90, which are transparent amorphous thermoplastics commercially available from EMS-Chemie Inc., Sumter, S.C.

In other embodiments, the substrate is a cellulosic-containing material. Non-limiting examples of cellulosic-containing materials include, for example, paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

In yet other embodiments, the substrate is a textile material. Non-limiting examples of suitable textile substrates include fibers, yams, threads, knits, wovens, nonwovens and garments composed of polyester, modified polyester, polyester blend fabrics, nylon, cotton, cotton blend fabrics, jute, flax, hemp and ramie, viscose, wool, leather, silk, polyamide, polyamide blend fabrics, polyacrylonitrile, triacetate, acetate, polycarbonate, polypropylene, polyvinyl chloride, polyester microfibers and glass fiber fabric. Non-limiting examples of suitable leather substrates include grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine/dicyanodiamide/and/or urea/formaldehyde resins.

In still other embodiments, the substrate is a compressible substrate. Non-limiting examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

In certain embodiments, the substrate is a silicatic substrate. Examples of suitable silicatic substrates include glass, porcelain and ceramics. Non-limiting examples of glass substrates include, for example, architectural glass, including window panes, automotive glass, and household and/or industrial glassware, such as, for example, drinking glasses, glassware for cooking and/or baking, commercial glassware, such as for packaging, labware, and the like.

In other embodiments, the substrate is an optical device. As used herein the term “optical” means pertaining to or associated with light and/or vision. For example, in certain embodiments, the optical element or device includes ophthalmic elements and devices, display elements and devices, windows, mirrors, and active and passive liquid crystal cell elements and devices. As used herein, the term “ophthalmic” means pertaining to or associated with the eye and vision. Non-limiting examples of ophthalmic elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors. As used herein, the term “display” means the visible or machine-readable representation of information in words, numbers, symbols, designs or drawings. Non-limiting examples of display elements and devices include screens, monitors, and security elements, such as security marks. As used herein, the term “window” means an aperture adapted to permit the transmission of radiation therethrough. Non-limiting examples of windows include building windows and doors, automotive and aircraft transparencies, filters, shutters, and optical switches. As used herein, the term “mirror” means a surface that specularly reflects a large fraction of incident light.

In yet other embodiments, the substrate of the present invention may be a surface of any variety of articles, including an exterior or interior member, window sash, structural member, or windowpane of a building; an exterior member or coating of a vehicle such as automobile, railway vehicle, aircraft, and watercraft; an exterior member, dust cover or coating of a machine, apparatus or article; an exterior member or coating of a traffic sign, various display devices, and advertisement towers; household articles, including toilet bowls, bath tubs, wash basins, lighting fixtures, kitchenware, tableware, sinks, cooking ranges, kitchen hoods, and ventilation fans, that are made, for example, of various metals e.g., steel, stainless steel, aluminum, and the like, ceramics, glass, plastics, wood, stone, cement, concrete, a combination thereof, a laminate thereof, or other materials.

As used herein, the term “wash basin” refers to a vessel in which to wash one's face and/or hands. As used herein, the term “sink” refers to a wash basin fixed to a wall or floor and having a drainpipe. As used herein, the term “kitchenware” refers to utensils and appliances for use in a kitchen, including, for example, pots and pans, toasters, etc. As used herein, the term “tableware” refers to articles for use at the table, including, for example, dishes, silverware, and glasses.

In certain embodiments, the substrate is a body of a motor vehicle. In these embodiments, the automotive body component (including, but not limited to, automobiles, trucks and tractors) can have any shape, and can be selected from the metallic and/or polymeric substrates described above. Typical automotive body components can include body side moldings, fenders, bumpers, hoods, and trim for automotive vehicles.

In other embodiments, the substrate is a masonry material. Non-limiting examples of suitable masonry materials include, for example, bricks; stones, such as marble, granite, travertine, and limestone; concrete; clays; and tiles. Composite masonry materials may also be suitable as a substrate, including, for example, asphalt concrete, mastic asphalt, and the like.

In certain embodiments, the substrate is an exterior member of a building. In these embodiments, an exterior member of a building may include the surface of any architectural and/or building component located on the exterior of a building, such as exterior walls; roofs; doors; and/or ornamental structures located on the building's exterior, for example, statues, signs, and the like. These surfaces may include a wide variety of materials, such as, plaster, masonry, concrete, metals (ferrous and non-ferrous), or wood, and may be coated with typical commercial paints including water-based and oil-based paints such as water-based latexes, water-based enamels, alkyds, acrylics, masonry paints, among others. In other embodiments, the substrate is an interior member of a building. The interior member of a building may include any conventionally known architectural and/or building component located on the interior of a building, such as wall boards, ceiling tiles, paneling, plywoods, particle boards, floors, doors, and the like, and may be coated with typical commercial paints as described above.

In certain embodiments, the substrate is one or more components of a rain gutter assembly, including, for example, a rain gutter, a rain gutter cover, which also may be referred to as a rain-water deflector, a downspout, a laminar flow generation device, and/or other components typically found in a rain gutter assembly, such as brackets and/or hangers for supporting the components of a rain gutter assembly. Suitable substrates may include any substrate as would be apparent to one skilled in the art typically used to manufacture components of a rain gutter assembly, including, for example, metallic substrates, including, aluminum, stainless steel, galvanized steel, as well as a variety of polymeric materials, and the like.

In certain embodiments, one or more of the components of the rain gutter assembly may be coated with a coating composition prior to application of the coating composition of the present invention. Suitable coating compositions include any coating composition as would be apparent to one skilled in the art, including, for example, any of those coating compositions described above.

In yet another embodiment, the substrate is a rain gutter cover. Suitable substrates may include any substrate as would be apparent to one skilled in the art typically used to manufacture components of a rain gutter cover, including, for example, metallic substrates, including, for example, aluminum, stainless steel, galvanized steel, as well as a variety of polymeric materials, and the like. In certain embodiments, the surface of the gutter cover may be smooth while, in other embodiments, the surface may include textures embossed in the substrate surface, for example, ribbed, stucco dimpled, pimpled, diamond pattern, and the like. In other embodiments, the surface of the rain gutter cover may be abraded and/or chemically cleaned. If any of the coating compositions mentioned above is present, these coating compositions may be present over a smooth surface or texture embossed surface, as described above.

After application to the substrate, the composition is dried and/or cured. As used herein, the term “cure” means that at least some crosslinkable components in the composition are at least partially crosslinked. In certain embodiments, the coating compositions of the present invention, upon application to a substrate, are cured at ambient conditions. As used herein, the term “ambient conditions” refers to the conditions of the surrounding environment (e.g., the temperature, humidity, and pressure of the room or outdoor environment in which the substrate is located). During the curing process, it is believed by the inventors, although not being bound to any one theory, that a portion of the silanol groups self condense (i.e., cross-link with each other) to cure the film on a substrate while other silanol groups do not self condense and are exposed at the surface of the cured film.

As previously indicated, certain embodiments of the coating compositions of the present invention can have a very low solids content, as low as 1 percent by weight, based on the total weight of the composition. Consequently, it has been found that certain embodiments of the coating compositions of the present invention can be applied to a substrate in the form of an extremely thin film. In particular, according to certain embodiments of the present invention, the composition is applied to a substrate in the form of a thin film that has a dry film thickness of no more than 0.5 mils (12.7 micrometers), such as no more than 0.05 mils (1.3 micrometers).

It has been found by the inventors that some embodiments of the coating compositions of the present invention produce a coating film having favorable application and appearance properties. As used herein, the term “coating film” refers to a dried and/or cured coating that is deposited upon a substrate, such films often are, but need not necessarily be, a continuous film. Such coatings also often exhibit hydrophilic properties at the surface thereof. One way to assess the hydrophilicity of a material is to measure the contact angle of water with the coating. Such a contact angle can be measured by the method described in the Examples herein. In certain embodiments, the coating compositions of the present invention produce a dry film on a substrate that exhibits a contact angle with water, when measured up to 24 hours after formation of the film, that is less than the contact angle that the substrate surface exhibits in the absence of such a coating. In certain embodiments, such a contact angle is at least 30% or, in some cases, at least 50%, or, in yet other cases, at least 75% less than the contact angle that the substrate surface exhibits in the absence of the coating.

As should be apparent, therefore, the present invention is also directed to coating films comprising a polymer comprising silanol groups that are present in an amount sufficient to render the coating film hydrophilic. As used herein, the term “hydrophilic” means that the coating film exhibits a contact angle with water, when measured up to 24 hours after formation of the film, that is less than the contact angle that the substrate surface would exhibit in the absence of such a coating film, such reductions can be at least 30% or, in some cases, at least 50%, or, in yet other cases, at least 75%.

As should also be apparent, the present invention is also directed to methods for imparting self cleaning properties to at least a portion of a substrate. The methods comprise (i) applying to the substrate a low-solids, aqueous coating composition comprising a polymer comprising silanol groups, and (ii) allowing the composition to cure such that the resulting coating film is hydrophilic.

In certain embodiments, such methods also comprise cleaning the substrate with an alkaline cleaner prior to application of a low-solids, aqueous coating composition of the present invention. The pH of such cleaners is often above 10.

In certain embodiments, after any cleaning and prior to application of a coating composition of the present invention, a pretreatment or “size coat” may be applied to the substrate. Such materials may comprise an organic solvent wipe of the substrate, for example, isopropanol or a mixture of two or more different alcohols. In some cases, the pretreatment may comprise application of a thin film of an adhesion promoting polymer solution and/or a “tie-coat.” In yet other cases, the pretreatment may comprise a polymeric solution which may improve the final appearance of the coated substrate.

Certain embodiments of the coating compositions of the present invention have shown to be particularly valuable for use in coating substrates that are continuously exposed to dust or dirt. It has been found that, in at least some cases, substrates at least partially coated with a composition of the present invention exhibit reduced sticking or caking of dust and/or dirt thereto.

One exemplary application involves the use of the composition to coat one of more components of a rain gutter assembly, such as, for example, a rain gutter cover. In certain embodiments, the rain gutter cover may be previously coated with a coating composition prior to application of the coating of the present invention. Once the rain gutter covers become dirty from exposure to typical weather conditions, it has been found that, in many cases, the dirt can be substantially removed by rinsing the gutter cover with water without the need for scrubbing, wiping, or applying harsh cleaners. Often times, rain water itself may substantially remove the dirt from a rain gutter cover coated with a composition of the present invention.

Another exemplary application involves the use of the composition to coat automobile wheel rims. Once the wheels become dirty from operation, specifically from brake dust, it has been found that, in many cases, the dust can be substantially removed by rinsing the wheel with water without the need for scrubbing, wiping, or applying harsh cleaners. As such, by coating a substrate with a composition of the present invention, cleaning times can, in many cases, be reduced.

Illustrating the invention are the following examples, which, however, are not to be considered as limiting the invention to their details. Unless otherwise indicated, all parts and percentages in the following examples, as well as throughout the specification, are by weight.

### EXAMPLES

### Examples 1-7

### Preparation of Acrylic Polymer

For each of Examples 1 to 7, see Table 1, a reaction flask was equipped with a stirrer, thermocouple, nitrogen inlet and a condenser. Charge A was then added and stirred with heat to reflux temperature (75° C.-80° C.) under nitrogen atmosphere. To the refluxing ethanol, charge B and charge C were simultaneously added over three hours. The reaction mixture was held at reflux condition for two hours. Charge D was then added over a period of 30 minutes. The reaction mixture was held at reflux condition for two hours and subsequently cooled to 30° C.

TABLE 1

| | 1 | 2 | 3 | 4 | 5 | 6 | 7 |
|---|---|---|---|---|---|---|---|
| Charge A (weight in | | | | | | | |
| grams) | | | | | | | |
| Ethanol SDA 40B¹ | 180.2 | 181 | 156.6 | 180.3 | 232.2 | 232.6 | 1145.0 |
| Charge B (weight in | | | | | | | |
| grams) | | | | | | | |
| Methyl Methacrylate | 15.2 | 30.0 | — | 15.1 | 13.4 | 32.8 | 109.7 |
| Methacrylic acid | 4.5 | 4.7 | 4.0 | — | — | — | — |
| Silquest A-174² | 52.9 | 38.2 | 59.1 | 52.8 | 77.7 | 60.0 | 322.9 |
| t-Butylaminoethyl | — | — | — | 4.6 | — | — | — |
| methacrylate | | | | | | | |
| Acrylic acid | — | — | — | — | 5.9 | 5.9 | 27.4 |
| 2- | — | — | — | — | 0.1 | 0.1 | 0.6 |
| hydroxylethylmethacrylate | | | | | | | |
| n-Butyl acrylate | — | — | — | — | 0.1 | 0.1 | 0.6 |
| Ethanol SDA 40B | — | — | — | — | — | — | 495.6 |
| Charge C (weight in | | | | | | | |
| grams) | | | | | | | |
| Vazo 67³ | 3.0 | 3.0 | 3.0 | 3.2 | 6.3 | 6.3 | 19.6 |
| Ethanol SDA 40B | 99.3 | 99.1 | 99.4 | 99.1 | 133.8 | 133.8 | 244 |
| Charge D (weight in | | | | | | | |
| grams) | | | | | | | |
| Vazo 67 | 0.8 | 0.8 | 0.8 | 0.9 | 1.0 | 1.1 | 5.0 |
| Ethanol SDA 40B | 25.2 | 25.0 | 25.2 | 25.1 | 33.8 | 33.8 | 28.9 |
| % Solids | 20.3 | 19.35 | 19.3 | 20.4 | 19.04 | 19.4 | 19.55 |
| Acid value (100% solids | 38.4 | 40.0 | 39.0 | — | 42.7 | 42 | 43 |
| basis) | | | | | | | |
| Amine value (100% solids | — | — | — | 18.1 | — | — | — |
| basis) | | | | | | | |

¹Denatured ethyl alcohol, 200 proof, available from Archer Daniel Midland Co.
²gamma-methacryloxypropyltrimethoxysilane, available from OSi Specialties Inc.
³2,2′-azo bis(2-methyl butyronitrile), available from E.I. DuPont de Nemours & Co., Inc.

### Examples 8-14

### Preparation of Coating Compositions

### Example 8

To 30.0 grams of the composition of Example 1, a mixture of 1.0 gram dimethylethanolamine and 120 grams of deionized water was added over 10 minutes under agitation. Then, the mixture was stirred for 30 minutes. The resulting mixture had a solids content of 4.5 percent by weight, and a pH of 9.13. The hydrolyzed polymer had a calculated silanol value (100% solids basis) of 531.3.

For purposes of the present invention, the silanol value for a polymer (100% solids basis) is calculated as follows: The total weight of monomers plus initiator in the composition is determined. For Example 1 this weight was 76.4 grams. The number of moles of silane-containing materials used is determined. For Example 1, 0.213 moles of Silquest A-174 was used, which was calculated by dividing 52.9 grams Silquest A-174 by 248 (the molecular weight of Silquest A-174). The number of equivalents of hydrolyzable ester groups in the polymer is then determined. For Example 1, this value was determined to be 0.639, which was calculated by multiplying the number of moles of Silquest A-174 by 3 (there are 3 ester groups on each Silquest A-174 molecule). The silanol ester equivalent weight for the polymer is then determined. For Example 1, this value was 119.6, which was calculated by dividing 76.4 by 0.639. It is to be assumed for purposes of calculating silanol value that each hydrolyzable ester group will release one methanol molecule and the weight loss for each methanol molecule released is 14 grams per mole. The silanol equivalent weight is then determined by subtracting 14 from the silanol ester equivalent weight. For Example 1, this was 105.6, which was calculated by subtracting 14 from 119.6. Silanol value is then determined by dividing 56,100, which is the molecular weight of KOH in milligrams, by the silanol equivalent weight. For Example 1 this was determined to be 531.3, which was calculated by dividing 56,100 by 105.6.

### Example 9

To 30 grams of the composition of Example 2, a mixture of 0.6 grams dimethylethanolamine and 10.0 grams of deionized water was added over a minute under agitation. The mixture was stirred for 4 minutes and 110 grams of water was added over minutes. Then, the mixture was stirred for 30 minutes. The resulting mixture had a solids content of 3.9 percent by weight and a pH of 8.6. The hydrolyzed polymer had a calculated silanol value (100% solids basis) of 369.1. Silanol value was calculated using the procedure described in Example 8.

### Example 10

To 30.9 grams of the composition of Example 3, a mixture of 1.0 gram dimethylethanolamine and 120 grams of deionized water was added over 10 minutes under agitation. Then, the mixture was stirred for 30 minutes. The resulting mixture had a solids content of 4.0 percent by weight and a pH of 9.2. The hydrolyzed polymer had a calculated silanol value (100% solids basis) of 705.0. Silanol value was calculated using the procedure described in Example 8.

### Example 11

To 15 grams of the composition of Example 4, a mixture of 0.4 grams acetic acid and 10.0 grams of deionized water was added over a minute under agitation. The mixture was stirred for 2 minutes and 50 grams of water was added over 5 minutes. Then, the mixture was stirred for 30 minutes. The resulting mixture had a solids content of 4.1 percent by weight and a pH of 4.6. The hydrolyzed polymer had a calculated silanol value (100% solids basis) of 529.6. Silanol value was calculated using the procedure described in Example 8.

### Example 12

To 100 grams of the composition of Example 5, a mixture of 14.43 grams of 10% dimethylethanolamine solution and 15.58 grams deionized water was added over 2 minutes with stirring. Then, over the course of 5 minutes, 270.01 grams of deionized water was added with stirring. The mixture was then stirred for an additional 23 minutes. The resulting mixture had a solids content of 5.0 percent by weight and a pH of 7.9. The hydrolyzed polymer had a calculated silanol value (100% solids basis) of 577.3. Silanol value was calculated using the procedure described in Example 8.

### Example 13

To 20 grams of the composition of Example 6, a mixture of 2.89 grams of 10% dimethylethanolamine solution and 27.09 grams deionized water was added with stirring over 2 minutes. Then, over the course of 5 minutes, 350.02 grams of deionized water was added with stirring. The mixture was then stirred for an additional 23 minutes. The resulting mixture had a solids content of 1 percent by weight and a pH of 7.7. The hydrolyzed polymer had a calculated silanol value (100% solids basis) of 423.5. Silanol value was calculated using the procedure described in Example 8.

### Example 14

To a stirred mixture of 995.8 grams water, 89.9 grams ethanol, 3.0 grams AEROSOL OT −75 (Sodium dioctyl sulphosuccinate available from Cytec Industries Inc., Kalamazoo, Mich.), 15.4 grams BYK-348 (Polyether modified dimethyl polysiloxane available from Byk-Chemie, Wesel Germany), 23.1 grams BYK 020 (Modified polysiloxane copolymer available from Byk-Chemie, Wesel Germany), 15.4 grams SURFYNOL 465 (Non-ionic surfactant available from Air Products and Chemicals Inc. Allentown, Pa.), and 10.7 grams dimethylethanolamine, 375.8 grams of the composition of Example 7 was added over 15 minutes. Then, the mixture was stirred for 30 minutes. The resulting mixture had a solids content of 6.5 percent by weight and a pH of 9.1. The hydrolyzed polymer had a calculated silanol value (100% solids basis) of 508.3 (calculated using the procedure described in Example 8). The mixture was diluted with an equal amount of water to spray as described in Example 20.

### Examples 15-18

### Test Substrates

The compositions of Examples 8 through 11 were each applied to clearcoated aluminum test panels, (epoxy-acid powder clearcoat supplied by PPG Industries Inc.), via applying approximately 2 milliliters of the composition to a paper towel and wiping the solution over the clearcoat surface. A film of the material was deposited on the panel. The material was allowed to dry in place at ambient conditions for four hours before testing for hydrophilicity. To determine hydrophilicity, the treated panel was immersed in a stream of running water for 5 seconds at an angle of 45 degrees and removed. The test panel was then set at a 90 degree angle where the water continued to wet the substrate in the form of a continuous sheet. The test was repeated on a similar panel without any surface treatment. In this case, water was observed to form beads which quickly rolled off of the panel.

### Example 19

### Surface Treatment Contact Angle Experiments

The compositions of Examples 8, 12 and 13 were applied to clearcoated aluminum test panels and allowed to dry in place at ambient conditions overnight. The panels were then examined for contact angle with water using a VCA 2500 XE Video Contact Angle System. Test specimens were also prepared for brake dust resistance testing as per the following procedure: A machine lathe was customized to hold a standard car rotor. Test panels were mounted perpendicularly on an aluminum block collar 1 inch from the rotor. A standard brake pad cut in half to reduce heat generation was applied to the spinning rotor (654 rpm) using a spring rated at 943 lb/inch (compressed 220 thousands of an inch) for three 10 minute sessions. After each 10 minute interval, the pad and rotor were disengaged for 3 minutes for cooling and to prevent pad glazing. The final result provided a blackened test panel with approximately 0.0150 g of brake dust accumulation. These panels were then rinsed with standard garden hose water pressure. The following table illustrates the results.

| Treatment | Contact | | |
|---|---|---|---|
| Example | Angle | Application | Brake Dust Resistance |
| 8 | 54° | Good uniform film | Excellent, no dust film, |
| | | | streaks or dirt marks |
| 12 | 57.3° | Good uniform film | Excellent, no dust film, |
| | | | streaks or dirt marks |
| 13 | 73.4° | Poor, dewetting of | Nearly as much dirt as the |
| | | treatment to surface | control. Dirty spots from |
| | | | dewetting on some areas |
| Control-no | 82° | NA | Poor, dusty film and |
| treatment | | | regions of streaks and/or |
| | | | dirt |

### Example 20

### Surface Treatment Automotive Wheel

The composition of Example 14 was spray applied to powder clearcoated aluminum test panels using a pump aerosol applicator and allowed to dry in place at ambient conditions overnight before testing. Contact angle with water was measured to be 5.8.degree. and simulated brake dust resistance testing produced excellent results with no brake dust film being retained after rinsing with water. A similar test panel without surface treatment was found to have a contact angle with water of 85 degree. The material was also spray applied to ½ of the right front wheel of a 2001 OLDSMOBILE ALERO and allowed to dry in place before returning the vehicle to service. After 600 miles of service the wheel was rinsed with a vigorous spray from a garden hose and the treated and untreated portions of the wheel were observed for differences. The untreated portion of the wheel was observed to already be collecting brake dust residue which could not be removed without mechanical agitation. The treated portion of the wheel was observed to have significantly less brake dust residue after rinsing with the same garden hose.

### Example 21

### Preparation of Acrylic Polymer

For this Example, see Table 3, a reaction flask was equipped with a stirrer, thermocouple, nitrogen inlet and a condenser. Charge A was then added and stirred with heat to reflux temperature (75° C.-80° C.) under nitrogen atmosphere. To the refluxing ethanol, charge B and charge C were simultaneously added over three hours. The reaction mixture was held at reflux condition for two hours. Charge D was then added over a period of 30 minutes. The reaction mixture was held at reflux condition for two hours and subsequently cooled to 30° C.

TABLE 3

| Charge A (weight in grams) | |
|---|---|
| Ethanol SDA 40B¹ | 537.4 |
| Charge B (weight in grams) | |
| Ethanol SDA 40B | 232.3 |
| Methyl Methacrylate | 51.5 |
| n-Butyl acrylate | 0.2 |
| 2-hydroxylethylmethacrylate | 0.2 |
| Acrylic acid | 12.9 |
| Silquest A-174² | 151.3 |
| Charge C (weight in grams) | |
| Vazo 67³ | 9.1 |
| Ethanol SDA 40B | 114.5 |
| Charge D (weight in grams) | |
| Vazo 67 | 2.3 |
| Ethanol SDA 40B | 13.5 |
| % Solids | 18.17 |
| Acid value (solution basis) | 8.79 |

¹Denatured ethyl alcohol, 200 proof, available from Archer Daniel Midland Co.
²gamma-methacryloxypropyltrimethoxysilane, available from OSi Specialties Inc.
³2,2′-azo bis(2-methyl butyronitrile), available from E.I. DuPont de Nemours & Co., Inc.

### Example 22

### Preparation of Coating Composition

To a 3 liter flask equipped with a reflux condenser, a stirrer and a thermocouple, the following materials were added under agitation: 1682.1 grams water, 59.9 grams ethanol, 2.0 grams AEROSOL OT −75 (Sodium dioctyl sulphosuccinate available from Cytec Industries Inc., Kalamazoo, Mich.), 10.2 grams BYK-348 (Polyether modified dimethyl polysiloxane available from Byk-Chemie, Wesel Germany), 10.2 grams SURFYNOL 465 (Non-ionic surfactant available from Air Products and Chemicals Inc. Allentown, Pa.), 7.0 grams diisobutyl ketone, and 7.1 grams dimethylethanolamine. The contents of the flask were stirred and heated to 30° C. To this stirred mixture, 250.0 grams of the composition of Example 21 was added under agitation over 30 minutes. Then, the mixture was stirred for 30 minutes. The resulting mixture had a solids content of 4.7 percent by weight and a pH of 8.9. The hydrolyzed polymer had a calculated silanol value (100% solids basis) of 509 (calculated using the procedure described in Example 8).

### Example 23

### Surface Treatment Substrate—Rain Gutter Cover

The composition of Example 22 was applied to a coated aluminum panel (19 gauge) that had been previously coated with a waterborne acrylic latex coil coating as sold under the trademark Environ® commercially available from PPG Industries, Inc. The composition was applied via applying approximately 2 milliliters of the composition to a paper towel and wiping the solution over the previously coated aluminum surface. A film of the material was deposited on the panel. The material was allowed to dry in place at ambient conditions for approximately 20 minutes before testing for hydrophilicity. To determine hydrophilicity, the treated panel was immersed in a stream of trickling running water for approximately 10 to 20 seconds at an angle of approximately 45 degrees. It was observed that the water continued to wet the substrate in the form of a continuous sheet. The test was repeated on a similar panel without any surface treatment. In this case, water was observed to form beads which quickly rolled off of the panel.

It will be appreciated by those skilled in the art that changes could be made to the embodiments described above without departing from the broad inventive concept thereof. Whereas particular embodiments of this invention have been described above for purposes of illustration, it will be evident to those skilled in the art that numerous variations of the details of the present invention may be made without departing from the invention as defined in the appended claims.

We claim:

1. A substrate at least partially coated with a low-solids, aqueous coating composition comprising a polymer comprising silanol functional groups that are present on the polymer in an amount sufficient to give the polymer a silanol value of at least 300, wherein the substrate is formed from a material selected from human and/or animal materials, plant materials, metallic materials, polymeric materials, cellulosic-containing materials, textile materials, compressible materials, silicatic materials, masonry materials, composites thereof and/or mixtures thereof.

2. The substrate of claim 1, wherein the coating composition has a resin solids content of 1 to 10 percent by weight, based on the total weight of the composition.

3. The substrate of claim 1, wherein the silanol functional groups are present on the polymer in an amount sufficient to give the polymer a silanol value of 400 to 800.

4. The substrate of claim 1, wherein the coating composition is in the form of an aqueous dispersion comprising the polymer comprising silanol functional groups.

5. The substrate of claim 1, wherein the polymer comprising silanol functional groups comprises an acrylic polymer.

6. The substrate of claim 5 wherein the acrylic polymer is synthesized from a combination of unsaturated polymerizable materials comprising: (i) a silane-containing ethylenically unsaturated polymerizable material, (ii) an ethylenically unsaturated polymerizable material comprising acid and/or anhydride groups, and (iii) an ethylenically unsaturated polymerizable material substantially free of acid, amine, silane, and/or hydroxyl groups.

7. The substrate of claim 1, wherein the polymer comprising silanol functional groups is present in an amount of at least 25 percent by weight based on the total weight of organic resin solids in the composition.

8. The substrate of claim 1, wherein the coating composition further comprises a non-polymeric silanol containing material.

9. The substrate of claim 8, wherein the non-polymeric silanol containing material comprises an essentially completely hydrolyzed organosilicate, silicic acid, and/or silica particles.

10. The substrate of claim 1, wherein the coating composition further comprises at least one surfactant.

11. The substrate of claim 10, wherein the surfactant is present in an amount ranging from 0.01 to 10 percent by weight based on the total weight of the composition.

12. The substrate of claim 1, where the substrate is a coated surface comprising a coating composition.

13. The substrate of claim 1, wherein the substrate is a metallic substrate.

14. The substrate of claim 13, wherein the substrate is aluminum.

15. The substrate of claim 1, wherein the substrate is a polymeric substrate.

16. The substrate of claim 1, wherein the substrate is a silicatic substrate.

17. The substrate of claim 1, wherein the substrate is a cellulosic-containing substrate.

18. The substrate of claim 13, wherein the substrate is one or more components of a rain gutter assembly.

19. The substrate of claim 15, wherein the substrate is one or more components of a rain gutter assembly.

20. The substrate of claim 18, wherein the substrate is a rain gutter cover.

21. The substrate of claim 19, wherein the substrate is a rain gutter cover.

22. The substrate of claim 1, wherein the substrate is a masonry material.
